(19) United States
(12) Patent Application Publication
(10) Pub. No.: US 2021/0334634 A1
(43) Pub. Date: Oct. 28, 2021

(54) METHOD AND APPARATUS FOR IMPLEMENTING AN ARTIFICIAL NEURON NETWORK IN AN INTEGRATED CIRCUIT

(71) Applicant: ST Microelectronics (Rousset) SAS, Rousset Cedex (FR)

(72) Inventors: Laurent Folliot, Gourdon (FR); Pierre Demaj, Nice (FR)

(21) Appl. No.: 17/226,598

(22) Filed: Apr. 9, 2021

(30) Foreign Application Priority Data
Apr. 23, 2020 (FR) 2004070

(51) Int. Cl. G06N 3/063; G06N 3/04

(52) U.S. Cl. CPC G06N 3/063; G06N 3/04

(57) ABSTRACT

An embodiment method for implementing an artificial neural network in an integrated circuit comprises obtaining an initial digital file representative of a neural network configured according to at least one data representation format, then detecting at least one format for representing at least part of the data of the neural network, then converting at least one detected representation format into a predefined representation format so as to obtain a modified digital file representative of the neural network, and then integrating the modified digital file into an integrated circuit memory.

### CROSS-REFERENCE TO RELATED APPLICATIONS

This application claims the benefit of French Application No. 2004070, filed on Apr. 23, 2020, which application is hereby incorporated herein by reference.

### TECHNICAL FIELD

Embodiments and implementations relate to artificial neural network apparatus and methods, and more particularly their implementation in an integrated circuit.

### BACKGROUND

Artificial neural networks generally comprise a succession of neuron layers.

Each layer takes as input data, to which weights are applied, and outputs output data after processing by functions for activating the neurons of the layer. These output data are transmitted to the next layer in the neural network.

The weights are data, more particularly parameters, of neurons that can be configured to obtain good output data.

The weights are adjusted during a generally supervised learning phase, in particular by executing the neural network with data already classified from a reference database as input data.

Neural networks can be quantified to speed up their execution and reduce memory requirements. In particular, the quantification of the neural network consists in defining a data representation format of the neural network, such as the weights as well as the inputs and outputs of each layer of the neural network.

In particular, neural networks are quantified according to a representation format of an integer. However, there are many possible representation formats for integers. In particular, the integers can be represented according to a signed or unsigned, symmetric or asymmetric representation. Furthermore, data from the same neural network can be represented in different integer representations.

Many industrial players are developing software infrastructures (“framework”), such as Tensorflow Lite® developed by the company Google or PyTorch, to develop quantified neural networks.

The choice of data representation format of the quantified neural network can vary according to the different actors developing these software infrastructures.

Quantified neural networks are trained and then integrated into integrated circuits, such as microcontrollers.

In particular, integration software can be provided in order to integrate a quantified neural network into an integrated circuit. For example, the integration software STM32Cube.AI and its extension X-CUBE-AI developed by the company STMicroelectronics are known.

### SUMMARY

Integration software can be configured to convert a quantized neural network into a neural network optimized to be executed on a given integrated circuit.

However, in order to be able to process quantified neural networks having different data representation formats, it is necessary that the integration software is compatible with all these different representation formats.

To be compatible, one solution is to specifically program the integration software for each representation format.

However, such a solution has the disadvantage of increasing the costs of development, validation and technical support. Furthermore, such a solution also has the disadvantage of increasing the size of the integration software code.

There is therefore a need to provide a method for implementing an artificial neural network in an integrated circuit allowing support of any type of representation format and which can be performed at low cost.

Furthermore, the integration software are configured to execute the neural network by a processor, this is called software execution, or at least partly by dedicated electronic circuits of the integrated circuit to speed up its execution. The dedicated electronic circuits can be logic circuits for example.

The processor and the dedicated electronic circuits can have different constraints. In particular, what may be optimal for the processor may not be optimal for a dedicated electronic circuit, and vice versa.

There is therefore also a need to provide an implementation method allowing improving, or even optimizing, the representation of the neural network according to the execution constraints of the neural network.

According to one aspect, a method for implementing an artificial neural network in an integrated circuit is proposed, the method comprising obtaining an initial digital file representative of a neural network configured according to at least one data representation format, then a) detecting at least one format for representing at least part of the data of the neural network, then b) converting at least one detected representation format into a predefined representation format so as to obtain a modified digital file representative of the neural network, and then c) integrating the modified digital file into an integrated circuit memory.

The neural network can be a neural network quantified and trained by an end user, for example using a software infrastructure such as Tensorflow Lite® or PyTorch.

Such an implementation method can be performed by integration software.

The neural network can be optimized, in particular by the integration software, before its integration into the integrated circuit.

Such an implementation method allows supporting any type of data representation format of the neural network while considerably reducing the costs for performing such an implementation method.

In particular, converting a detected data representation format of the neural network into a predefined data representation format allows limiting the number of representation formats to be supported by integration software.

More particularly, the integration software can be programmed to support only predefined data representation formats, in particular for optimizing the neural network. The conversion allows the neural network to be adapted for use by the integration software.

Such an implementation method allows simplifying the programming of the integration software and to reduce the memory size of the integration software code.

Such an implementation method thus allows for integration software to be able to support neural networks generated by any software infrastructure independently of the quantification parameters selected by the end user.

The neural network usually comprises a succession of neuron layers. Each neuron layer receives input data and outputs output data. These output data are taken as input of at least one subsequent layer in the neural network.

In an advantageous embodiment, the conversion of the representation format of at least part of the data is carried out for at least one layer of the neural network.

Preferably, the conversion of the representation format of at least part of the data is carried out for each layer of the neural network.

Advantageously, the neural network comprises a succession of layers, and the data of the neural network include weights assigned to the layers as well as input data and output data which can be generated and used by the neural network layers.

In particular, when the detection allows detecting that the representation format of the weights is an unsigned format, the conversion may comprise a modification of the weight representation of the signed values as well as a modification of the value of the data representing these weights.

Alternatively, when the detection allows detecting that the weight representation format is a signed format, the conversion may comprise a modification of the weight representation into unsigned values as well as a modification of the value of the data representing these weights.

Moreover, when the detection allows detecting that the representation format of the input data and the output data of each layer is an unsigned format, the conversion may comprise a modification of the representation of the input data and the output data into signed values.

Alternatively, when the detection allows detecting that the representation format of the input data and the output data of each layer is a signed representation format, the conversion may comprise a modification of the representation of the input data and the output data into unsigned values.

Furthermore, the conversion comprises the addition of a first conversion layer at the input of the neural network configured to modify the value of the data that can be inputted to the neural network according to the predefined representation format, and the addition of a second layer for conversion at the output of the neural network configured to modify the value of the output data of a last neural network layer according to a format for representing the output data of the initial digital file.

Preferably, the predefined representation format is selected according to the execution material of the neural network. In particular, the predefined representation format is selected according to whether the neural network is executed by a processor or at least partly by dedicated electronic circuits so as to speed up its execution.

In this way, it is possible to take into account the constraints of the execution hardware to optimize the execution of the neural network.

In particular, preferably, when the choice is made to execute the neural network by a processor and when the neural network weights are represented according to an asymmetric representation format, the predefined representation format of the weights is an unsigned and asymmetric format, and the predefined representation format of the input and output data of each layer is an unsigned and asymmetric format.

Furthermore, preferably, when the choice is made to execute the neural network by a processor and when the neural network weights are represented according to a symmetric representation format, the predefined representation format of the weights is a signed and symmetric format, and the predefined representation format of the input and output data of each layer is an unsigned and asymmetric format. However, alternatively, the predefined representation format of the input and output data of each layer and the predefined representation format of the weights can be an unsigned and asymmetric format.

Moreover, preferably, when the choice is made to execute the neural network using dedicated electronic circuits and when the neural network weights are represented according to a symmetric representation format, the predefined representation format of the weights is a signed and symmetric format, and the predefined representation format of the input and output data of each layer is a signed and asymmetric format, or an asymmetric and unsigned format if the dedicated electronic circuits are configured to support an unsigned arithmetic.

Furthermore, preferably, when the choice is made to at least partly execute the neural network using dedicated electronic circuits and when the neural network weights are represented according to an asymmetric representation format, the predefined representation format of the weights is a signed and asymmetric format, and the predefined representation format of the input and output data of each layer is a signed and asymmetric format, or an asymmetric and unsigned format if the dedicated electronic circuits are configured to support an unsigned arithmetic.

According to another aspect, a computer program product is proposed, comprising instructions which, when the program is executed by a computer, lead the latter to carry out steps a) and b) and c) of the method as described previously.

According to another aspect, a computer-readable data medium is proposed, on which a computer program product as described above is recorded.

According to another aspect, a computer-based tool is proposed, for example a computer, comprising an input for receiving an initial digital file representative of a neural network configured according to at least one data representation format, and a processing unit configured to perform a detection of at least one format for representing at least part of the data of the neural network, then a conversion of at least one detected representation format into a predefined representation format so as to obtain a modified digital file representative of the neural network, then an integration of the modified digital file into an integrated circuit memory.

Thus, a computer-based tool is provided, comprising a data medium as described above, as well as a processing unit configured to execute a computer program product as described above.

### BRIEF DESCRIPTION OF THE DRAWINGS

Other advantages and features of the invention will appear upon examining the detailed description of non-limiting implementations and embodiments and the appended drawings wherein:

FIG. 1 illustrates an embodiment implementation method; and

FIG. 2 schematically illustrates an embodiment computer-based tool.

### DETAILED DESCRIPTION OF ILLUSTRATIVE EMBODIMENTS

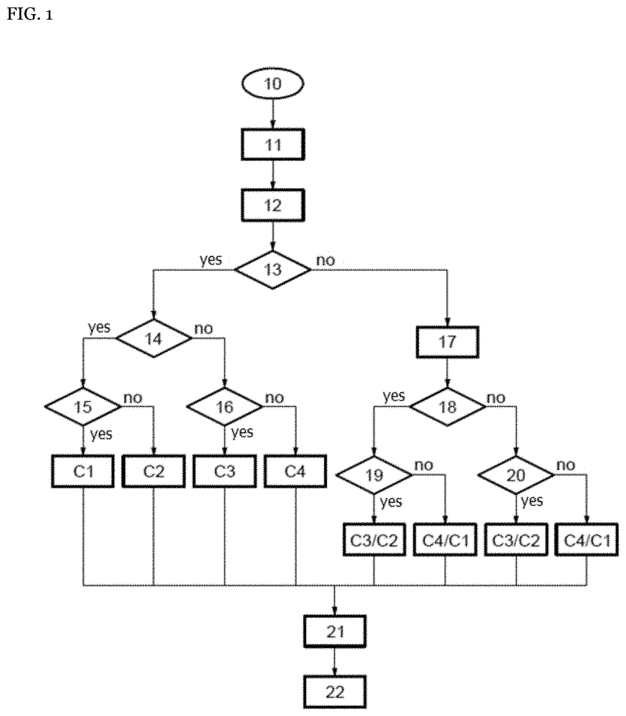

FIG. 1 shows an implementation method according to an implementation of the invention. This implementation method can be performed by integration software.

The method firstly comprises an obtention step 10 wherein an initial digital file representative of a neural network is obtained. This neural network is configured according to at least one data representation format.

In particular, the neural network usually comprises a succession of neuron layers.

Each neuron layer receives input data to which weights are applied and outputs output data.

The input data can be data received at the input of the neural network or else output data from a previous layer.

The output data can be data outputted from the neural network or else data generated by a layer and inputted to a next layer of the neural network.

The weights are data, more particularly parameters, of neurons that can be configured to obtain good output data.

In particular, the neural network is a neural network quantified and trained by a user, for example using a software infrastructure such as Tensorflow Lite® or PyTorch. In particular, such training allows defining weights.

The neural network then has at least one representation format selected for example by the user for its input data of each layer, its output data of each layer and for the weights of the neurons of each layer. In particular, the input data and the output data of each layer as well as the weights are integers that can be represented according to a signed or unsigned, symmetric or asymmetric format.

The initial digital file contains one or more indications allowing identifying of the representation format(s). Such indications can in particular be represented in the initial digital file, for example in the form of a binary file.

Alternatively, these indications may be in the form of a quantized file.tflite which, as indicated below, may contain the quantisation pieces of information such as the scale s and the value zp representative of a zero point.

The initial digital file is provided to the integration software.

The integration software is programmed to optimize the neural network. In particular, the integration software allows for example to optimize a network topology, an order of execution of the elements of the neural networks or else to optimize a memory allocation which can be performed during the execution of the neural network.

In order to simplify the programming of the integration software, the optimisation of the neural network is programmed to operate with a limited number of data representation formats. These representation formats are predefined and detailed below.

The integration software is programmed to be able to convert any type of data representation format into a predefined representation format before optimisation, in order to support any type of data representation format.

In this way, the integration software is configured to allow the optimisation of the neural network from a neural network which can be configured according to any type of data representation format.

This conversion step is comprised in the implementation method.

In particular, this conversion step is adapted to modify a symmetric representation format into an asymmetric representation format. This conversion step is also adapted to modify a signed representation format into an unsigned representation format, and vice versa. The way this conversion step works will be described in more detail below.

In order to improve the understanding of how the conversion works, it should be remembered that a floating-point integer quantized on n-bits can be expressed in the following form:

[Math 1]

r=s×(q−zp), where q and zp are integers on n-bits with the same signed or unsigned representation format and s is a predefined floating-point scale. The scale s and the value zp representative of a zero point can be contained in the initial digital file.

This form is known to a person skilled in the art, and is for example described in the specification of TensorFlow Lite concerning the quantification. This specification is available in particular on the website: https://www.tensorflow.org/lite/performance/quantisation_spec.

In particular, for the data in a symmetric representation format, the value zp is zero.

Thus, the symmetric representation format can be considered as an asymmetric representation format with zp equal to o.

Changing the representation format of the weights of each layer from an unsigned representation format to an unsigned representation format, or vice versa, can be obtained as indicated below.

The weights of each layer in an unsigned representation format can be expressed in the following form:

[Math 2]

r_{w}=s_{w}×(q_{w}−zp_{w}), where q_{w} and zp_{w} are unsigned data in the interval [o; 2ⁿ−1].

It is possible to obtain a signed representation format of the weights by applying the following formula:

[Math 3]

r_{w}=s_{w}×(q_{w2}−zp_{w2}), where q_{w2}=q_{w}−2ⁿ⁻¹ and zp_{w2}=zp_{w}−2ⁿ⁻¹ are signed input data in the interval [−2ⁿ⁻¹2ⁿ⁻¹−1].

It is possible to obtain an unsigned representation format of the weights by applying the following formula:

[Math 4]

r_{w}=s_{w}×(q_{w}−zp_{w}), where q_{w}=q_{w2}+2ⁿ⁻¹ and zp_{w}=zp_{w2}+2ⁿ⁻¹, where q_{w2} and zp_{w2} are signed input data in the interval [−2ⁿ⁻¹2ⁿ⁻¹−1].

The change of representation format of the input and output data of each layer from a signed representation format to an unsigned representation format, or vice versa, can be obtained as indicated below.

The input data of each layer according to a signed representation format can be expressed in the following form:

[Math 5]

rᵢ=sᵢ×(qᵢ−zpᵢ), where qᵢ and zpᵢ are signed input data in the interval [−2ⁿ⁻¹; 2ⁿ⁻¹−1], with n being the number of bits used to represent this signed input data.

It is possible to obtain an unsigned representation format of the input data by applying the following formula:

[Math 6]

rᵢ=sᵢ×(qᵢ₂−zpᵢ₂), where qᵢ₂=qᵢ+2ⁿ⁻¹ and zpᵢ₂=zpᵢ+2ⁿ⁻¹ are unsigned data in the interval [O; 2ⁿ−1].

It is also possible to obtain a signed representation format of the input data by applying the following formula:

[Math 7]

rᵢ=sᵢ×(qᵢ−zpᵢ), where qᵢ=qᵢ₂−2ⁿ⁻¹ and zpᵢ=zpᵢ₂−2ⁿ⁻¹, where qᵢ₂ and zpᵢ₂ are unsigned input data in the interval [o; 2ⁿ−1].

The output data of each layer according to a signed representation format can be expressed in the following form:

[Math 8]

rₒ=sₒ×(gₒ−zpₒ), where qₒ and zpₒ are signed output data in the interval [−2ⁿ⁻¹; 2ⁿ⁻¹−1].

The output data of each layer are in particular calculated according to the following formula:

rₒ=rᵢ×r_{w} [Math 9]

Thus, it is possible to obtain an unsigned representation format for the output data of the neural network layers, for example convolutional layers or dense layers, by applying the following formula:

[Math 10]

rₒ=sₒ×(qₒ₂−zpₒ₂), where qₒ₂=qₒ+2ⁿ⁻¹ and zpₒ₂=zpₒ+2ⁿ⁻¹, qₒ₂ and zpₒ₂ are unsigned data in the interval [o; 2ⁿ−1].

It is also possible to obtain a signed representation format of the output data by applying the following formula:

[Math 11]

rₒ=sₒ×(qₒ−zpₒ), where qₒ=qₒ₂−2ⁿ⁻¹ and zpₒ=zpₒ₂−2ⁿ⁻¹, q_{O2} and zpₒ₂ are unsigned in the interval [o; 2ⁿ−1].

When the representation format of a layer input data is converted from unsigned to signed, the output data qₒ of this same layer will also be signed when the datum zpₒ is converted into signed.

Thus, a modification of the representation format of the input data of the neural network from unsigned to signed and the representation format of the data zpₒ of each layer allows directly obtaining data qₒ which are used as input data of the next layer. It is therefore not necessary to modify the value of the output data between two successive layers during the execution of the neural network.

In particular, the conversion of the representation format of the input and output data may require the addition of a first conversion layer at the input of the neural network to convert the data at the input of the network in the desired representation format for the execution of the neural network and a second layer at the output of the neural network for conversion into a representation format desired by the user at the output of the neural network.

In order to adapt the data representation format, the method comprises a step 11 of detecting the execution material with which the neural network must be executed if this execution material is indicated by the user.

In particular, the neural network can be executed by a processor, this is then called software execution, or at least partly by a dedicated electronic circuit. The dedicated electronic circuit is configured to perform a defined function to speed up the execution of the neural network. The dedicated electronic circuit can for example be obtained from programming in VHDL language.

The method comprises a step of detecting at least one format for representing the data of the neural network.

Preferably, each data representation format of the neural network is detected.

In particular, the format for representing the input and output data of each layer is detected as well as the weight representation formats of the neurons of each layer.

Then, the implementation method allows converting, if necessary, the detected representation format of the input and output data of each layer as well as the detected representation format of the weights of the neurons of each layer.

This conversion can be performed according to the execution constraints of the neural network, in particular according to whether the neural network is executed by a processor or by a dedicated electronic circuit.

Indeed, the processor and the dedicated electronic circuit can have different constraints. For example, when the neural network is at least partly executed by a dedicated electronic circuit, it is not possible to change an asymmetric representation format to a symmetric representation format without modifying the number of bits representing the datum.

Thus, for example, a conversion from an asymmetric representation format of a weight to a symmetric representation format of this weight leads either to a weight represented on a higher number of bits to maintain the precision, which nevertheless increases the execution time of the neural network, or to a reduction in precision by keeping the number of bits to maintain the execution time.

Thus, preferably, when the detected representation format of a datum of the neural network is asymmetric, it is here preferred to keep this asymmetric representation format.

Moreover, if the neural network uses activation functions such as ReLU (from “Rectified Linear Units”) or Sigmoid, it is preferable to use an unsigned representation format. Indeed, a signed representation format increases the execution time of these activation functions.

Thus, the method comprises a step 13 of verifying an identification of an execution material. In this step, it is verified whether the user has indicated the execution material on which the neural network must be executed.

In particular, the user can indicate whether the neural network should be executed by the processor or at least partly by a dedicated electronic circuit.

Also the user may not indicate the execution material.

If in step 13 it is determined that the user has indicated the execution material to be used, the method comprises a determination step 14 wherein it is determined whether the neural network must be executed by the processor or by dedicated electronic circuits.

More particularly, if in step 14, it is determined that the neural network must be executed by the processor then the method comprises a step 15 wherein it is determined whether the weight representation format is asymmetric.

If the answer in step 15 is yes, the weight representation format is asymmetric, then the data representation format is converted according to a conversion C1. The conversion C1 allows obtaining an unsigned and asymmetric weight representation format, and a representation format of the input and output data of each unsigned and asymmetric layer. For this purpose, the formula [Math 4] is applied for the weights if their original representation format is signed, and the formulas [Math 6], [Math 10] are applied for the input data and the output data of each layer if their original representation format is signed.

If in step 15 the answer is no, the weight representation format is symmetric, then the data representation format is converted according to a conversion C2. The conversion C2 allows obtaining a signed and symmetric weight representation format, and a predefined representation format of the input and output data of each unsigned and asymmetric layer. For this purpose, the formula [Math 3] is applied for the weights if their original representation format is unsigned, and the formulas [Math 6] and [Math 10] are applied for the input data and the output data of each layer if their original representation format is signed. If in step 14 the answer is no, the neural network must be executed using dedicated electronic circuits, then the method comprises a step 16 wherein it is determined whether the weight representation format is symmetric.

If the answer in step 16 is no, the weight representation format is symmetric, then the data representation format is converted according to a conversion C3. The conversion C3 allows obtaining a signed and symmetric weight representation format, and a representation format for the input and output data of each signed and asymmetric layer. For this purpose, the formula [Math 3] is applied for the weights and the formulas [Math 7] and [Math 11] are applied for the input data and the output data of each layer if their original format is a signed representation format.

Instead of performing the conversion C3, it is also possible to perform the conversion C2 if the dedicated electronic circuits support an unsigned arithmetic.

If in step 16 the answer is no, the weight representation format is asymmetric, then the data representation format is converted according to a conversion C4. The conversion C4 allows obtaining a signed and asymmetric weight representation format, and a representation format for the input and output data of each signed and asymmetric layer. For this purpose, the formula [Math 3] is applied for the weights and the formulas [Math 10] and [Math 11] are applied for the input data and the output data of each layer if their original format is a signed representation format.

Instead of performing the conversion C4, it is also possible to perform the conversion C1 if the dedicated electronic circuits support an unsigned arithmetic.

If in step 13 the answer is no, it is determined that the user has not indicated the execution material, the method comprises a step 17 of analyzing the neural network.

The analysis allows determining in step 18 whether the neural network should be completely or partially executed using dedicated electronic circuits and partially by a processor.

If in step 18 the answer is yes, the neural network must be completely executed using dedicated electronic circuits, then the method comprises a step 19 wherein it is determined whether the weight representation format is symmetric.

If in step 19 the answer is yes, the weight representation format is symmetric, then the data representation format is converted according to the conversion C3 described above, or else according to the conversion C2 also described above if the dedicated electronic circuits support an unsigned arithmetic.

If in step 19 the answer is no, the weight representation format is asymmetric, then the data representation format is converted according to the conversion C4 described above, or else according to the conversion C1 also described above if the dedicated electronic circuits support an unsigned arithmetic.

If in step 18 the answer is no, the neural network must be partially executed using dedicated electronic circuits, then the method comprises a step 20 wherein it is determined whether the weight representation format is symmetric.

If in step 20 the answer is yes, the weight representation format is symmetric, then the data representation format is converted according to the conversion C3 described above, or else according to the conversion C2 also described above if the dedicated electronic circuits support an unsigned arithmetic.

If in step 20 the answer is no, the weight representation format is asymmetric, then the data representation format is converted according to the conversion C4 described above, or else according to the conversion C1 also described above if the dedicated electronic circuits support an unsigned arithmetic.

These conversions allow obtaining a modified digital file representative of the neural network.

The implementation method then comprises a step 21 for generating an optimized code.

The implementation method finally comprises a step 22 of integrating the optimized neural network into an integrated circuit.

Such an implementation method allows supporting any type of data representation format of the neural network while considerably reducing the costs of performing such an implementation method.

In particular, converting a detected data representation format of the neural network into a predefined data representation format allows limiting the number of representation formats to be supported by integration software.

More particularly, the integration software can be programmed to support only predefined data representation formats, in particular for optimizing the neural network. The conversion allows the neural network to be adapted to be used by the integration software.

Such an implementation method allows simplifying the programming of the integration software and to reduce the memory size of the integration software code.

Such an implementation method thus enables integration software to be able to support neural networks generated by any software infrastructure.

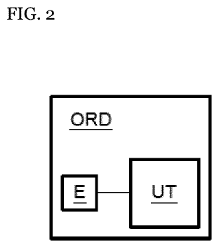

FIG. 2 shows a computer-based tool ORD comprising an input E for receiving the initial digital file and a processing unit UT programmed to perform the conversion method described above allowing obtaining of the modified digital file and to integrate the neural network according to this digital file modified in an integrated circuit memory, for example a microcontroller of the STM family 32 from the company STMicroelectronics, intended to implement the neural network.

Such an integrated circuit can for example be incorporated within a cellular mobile phone or a tablet.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for implementing an artificial neural network in an integrated circuit, the method comprising:
obtaining an initial digital file representative of a neural network configured according to one or more data representation formats;
detecting at least one representation format representing at least part of data of the neural network;
converting the at least one detected representation format into a predefined representation format to obtain a modified digital file representative of the neural network; and
integrating the modified digital file into a memory of the integrated circuit.

2. The method according to claim 1, wherein the converting the at least one detected representation format of at least part of the data is carried out for at least one layer of the neural network.

3. The method according to claim 1, wherein the converting the at least one detected representation format of at least part of the data is carried out for each layer of the neural network.

4. The method according to claim 1, wherein the converting comprises:
adding a first conversion layer at an input of the neural network configured to modify a value of input data that is inputted to the neural network according to the predefined representation format; and
adding a second layer for conversion at an output of the neural network configured to modify a value of output data of a last neural network layer according to a format for representing the output data of the initial digital file.

5. The method according to claim 1, wherein the neural network comprises a succession of neural network layers, and the data of the neural network include weights assigned to the neural network layers as well as input data and output data that is generated and used by the neural network layers.

6. The method according to claim 5, wherein the detecting comprises detecting that a weight representation format of the weights is an unsigned format, and the converting comprises a modification of the weight representation format into a signed value as well as a modification of data values representing the weights.

7. The method according to claim 5, wherein the detecting comprises detecting that a weight representation format of the weights is a signed format, and the converting comprises a modification of the weight representation format into an unsigned value as well as a modification of data values representing the weights.

8. The method according to claim 5, wherein the detecting comprises detecting that the representation format of the input data and the output data of each layer is an unsigned format, and the converting comprises a modification of a representation of the input data and the output data into signed values.

9. The method according to claim 5, wherein the detecting comprises detecting that the input data and the output data of each layer are represented in signed values, and the converting comprises a modification of a representation of the input data and the output data into unsigned values.

10. The method according to claim 5, further comprising:
selecting to execute the neural network by a processor, the weights being represented according to an asymmetric representation format;
setting the predefined representation format of the weights to an unsigned and asymmetric format; and
setting the predefined representation format of the input and output data of each layer to the unsigned and asymmetric format.

11. The method according to claim 5, further comprising:
selecting to execute the neural network by a processor, the weights being represented according to a symmetric representation format;
setting the predefined representation format of the weights to a signed and symmetric format; and
setting the predefined representation format of the input and output data of each layer to an unsigned and asymmetric format.

12. The method according to claim 5, further comprising:
selecting to execute the neural network using dedicated electronic circuits;
representing the weights according to a symmetric representation format;
setting the predefined representation format of the weights to a signed and symmetric format; and
setting the predefined representation format of the input and output data of each layer to an asymmetric and unsigned format in response to the dedicated electronic circuits being configured to support an unsigned arithmetic, or to a signed and asymmetric format otherwise.

13. The method according to claim 5, further comprising:
selecting to at least partly execute the neural network using dedicated electronic circuits;
representing the weights according to an asymmetric representation format;
setting the predefined representation format of the weights to a signed and asymmetric format; and
setting the predefined representation format of the input and output data of each layer to an asymmetric and unsigned format in response to the dedicated electronic circuits being configured to support an unsigned arithmetic, or to the signed and asymmetric format otherwise.

14. A computer program product comprising instructions which, when the instructions are executed by a computer, directs the computer to:
detect at least one representation format representing at least part of data of a neural network represented by an initial digital file; and
convert the at least one detected representation format into a predefined representation format to obtain a modified digital file representative of the neural network.

15. The computer program product according to claim 14, which further directs the computer to integrate the modified digital file into a memory of an integrated circuit.

16. A computer-based tool comprising:
an input configured to receive an initial digital file representative of a neural network configured according to one or more data representation formats; and
a processing unit communicatively coupled to the input and configured to:
detect at least one representation format representing at least part of data of the neural network;
convert the at least one detected representation format into a predefined representation format to obtain a modified digital file representative of the neural network; and
integrate the modified digital file into a memory of an integrated circuit.

17. The computer-based tool according to claim 16, wherein the processing unit configured to convert the at least one detected representation format of at least part of the data is carried out for at least one layer of the neural network.

18. The computer-based tool according to claim 16, wherein the processing unit configured to convert the at least one detected representation format of at least part of the data is carried out for each layer of the neural network.

19. The computer-based tool according to claim 16, wherein the processing unit configured to convert comprises the processing unit configured to:
add a first conversion layer at an input of the neural network configured to modify a value of input data that is inputted to the neural network according to the predefined representation format; and
add a second layer for conversion at an output of the neural network configured to modify a value of output data of a last neural network layer according to a format for representing the output data of the initial digital file.

20. The computer-based tool according to claim 16, wherein the neural network comprises a succession of neural network layers, and the data of the neural network include weights assigned to the neural network layers as well as input data and output data that is generated and used by the neural network layers.
